(19) United States
(12) Patent Application Publication
(10) Pub. No.: US 2024/0086906 A1
(43) Pub. Date: Mar. 14, 2024

(54) METHOD AND SYSTEM FOR PROVIDING TOKEN IDENTITY

(71) Applicant: Mastercard International Incorporated, Purchase, NY (US)

(72) Inventors: Ricardo SOTA, New York, NY (US); Saravana Perumal SHANMUGAM, Fremont, CA (US); Mohammed Sadiq AHMAD, Dublin, CA (US); Rajasekaran DHAMODHARAN, San Carlos, CA (US)

(73) Assignee: Mastercard International Incorporated, Purchase, NY (US)

(21) Appl. No.: 18/367,670

(22) Filed: Sep. 13, 2023

Related U.S. Application Data
(60) Provisional application No. 63/406,521, filed on Sep. 14, 2022.

(51) Int. Cl. G06Q 20/38; G06Q 20/02; G06Q 20/22; G06Q 20/36

(52) U.S. Cl. CPC G06Q 20/3829; G06Q 20/02; G06Q 20/223; G06Q 20/3674

(57) ABSTRACT

A method for facilitating permission-based cryptographic transactions across service providers includes: receiving an onboarding request including permission data and an identification value from a first computing system, the identification value being associated with a first blockchain wallet for a blockchain associated with a blockchain network; generating a permission token based on the permission data and an alias, the permission token including verified identity data points; transmitting the generated alias to the first computing system in response to the onboarding request; receiving a token request from a second computing system, the token request including the alias; and transmitting the generated permission token identification value to the second computing system in response to the token request.

### FIELD

The present disclosure relates to the providing of token identities, specifically the use of permission tokens to facilitate cryptographic transactions across service providers that are compliant with identity verification requirements without the need for transmission or exchange of personally identifiable information.

### BACKGROUND

Blockchain was initially created to provide a platform through which cryptographic currency could be traded. Two of major tenets in the creation of blockchain are that the blockchain itself would be entirely decentralized, being stored on and managed via a vast distribution of computing systems, and that the cryptocurrency transactions could be conducted with full anonymity, where no identification information needed to be provided to participant and all transactions were between blockchain wallets without regard for ownership thereof. These two tenets led to a large adoption in blockchain and its use in the creation and management of a vast number and variety of cryptographic currencies.

However, the popularity of blockchain when combined with the decentralization and anonymization has resulted in a drastic amount of fraud in cryptographic transactions to the tune of consumers losing over one billion dollars in 2021 in just the United States alone. The lack of a central authority to regulate transactions can leave users at a disadvantage, while anonymity provides little recourse to those taken advantage of as well as an inability to catch and stop fraudulent actors. To combat fraudulent activity, many countries have established policies, regulations, and requirements for identity verification for blockchain participants as well as rules regarding participants in blockchain transactions.

In order to comply with these new policies and regulations, virtual asset service providers (VASPs) that operate cryptographic currency exchanges or blockchain wallets on behalf of participants perform identity verification processes for their participants. However, a vast portion of cryptographic transactions occur between participants that use different VASPs, resulting in each VASP still having to verify the identity of the other user transacting with their participant, which can be a difficult process and which also exposes personally identifiable information (PII) of the participant and other user with the other VASPs. Furthermore, a significant number of cryptographic transactions occur between participants in different countries, where each country has their own applicable policies and regulations. This requires a VASP to not only verify the identity of the other user to a transaction with its participant, but also verify that their participant and the other user both comply with the applicable regulations in the other country, with which the VASP could be unfamiliar.

As a result, current systems require all VASPs to be familiar with the applicable regulations for every country where a blockchain participant is located and require all VASPs to readily exchange user PII to ensure compliance with the applicable regulations, which can be a very difficult, time consuming, and costly task as well as drastically increase the opportunity for a user's PII to be compromised. Thus, there is a need for a technological solution to ensure compliance of cryptographic transactions without the exchange of PII or requiring VASPs to keep apprised of the applicable regulations in every potential transacting country.

### SUMMARY

The present disclosure provides a description of systems and methods for facilitating permission-based cryptographic transactions across service providers. A new user for a blockchain can verify their identity through their virtual asset service provider (VASP) through whom they interact with the blockchain. The VASP can verify the user's identity and any aspects thereof that could be applicable for regulations on cryptographic transactions. The VASP can register the user with a token identity service by providing data points with respect to verified user identity attributes. The token identity service can generate a permission token for that user based on their verified user identity attributes and return an alias to the VASP that the user can use when involved in cryptographic transactions. When transacting, the user can provide their alias to the other party. The other party can provide the alias to their VASP when requesting to send or receive cryptographic currency from the user. The other party's VASP can provide the alias to the token identity service, which can return the permission token for the user, which includes all the information necessary for the other party's VASP to ensure that the user has been properly verified sufficient for any applicable regulations known to the other party's VASP. The other party's VASP can then submit a new cryptographic currency transaction to the blockchain, which is fully compliant, and where no PII for either participant is exchanged and where each VASP only needs to verify the identities of their own users.

A method for facilitating permission-based cryptographic transactions across service providers includes: receiving, by a receiver of a processing server, an onboarding request including at least permission data and an identification value from a first computing system, wherein the identification value is associated with a first blockchain wallet for a blockchain associated with a blockchain network; generating, by a processor of the processing server, a permission token based on at least the permission data and an alias, wherein the permission token includes one or more verified identity data points; transmitting, by a transmitter of the processing server, the generated alias to the first computing system in response to the received onboarding request; receiving, by the receiver of the processing server, a token request from a second computing system, wherein the token request includes the alias; and transmitting, by the transmitter of the processing server, at least the generated permission token and the identification value to the second computing system in response to the received token request.

A system for facilitating permission-based cryptographic transactions across service providers includes: a blockchain network; a first computing system; a second computing system; and a processing server, the processing server including a receiver receiving an onboarding request including at least permission data and an identification value from the first computing system, wherein the identification value is associated with a first blockchain wallet for a blockchain associated with the blockchain network, a processor generating a permission token based on at least the permission data and an alias, wherein the permission token includes one or more verified identity data points, and a transmitter transmitting the generated alias to the first computing system in response to the received onboarding request, wherein the receiver of the processing server receives a token request from the second computing system, wherein the token request includes the alias, and the transmitter of the processing server transmits at least the generated permission token and the identification value to the second computing system in response to the received token request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for facilitating permission-based cryptographic transactions in accordance with exemplary embodiments.

FIG. 2 is a block diagram illustrating the processing server in the system of FIG. 1 for facilitating permission-based cryptographic transactions in accordance with exemplary embodiments.

FIGS. 3A and 3B are a flow diagram illustrating a process for facilitating permission-based cryptographic transactions across service providers in the system of FIG. 1 in accordance with exemplary embodiments.

FIG. 4 is a flow chart illustrating an exemplary method for facilitating permission-based cryptographic transactions across service providers in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Permission-Based Cryptographic Transactions

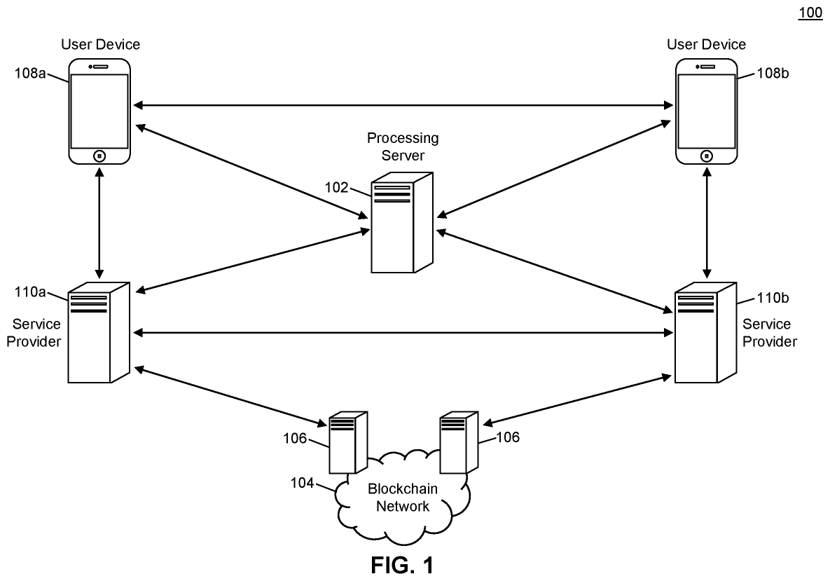

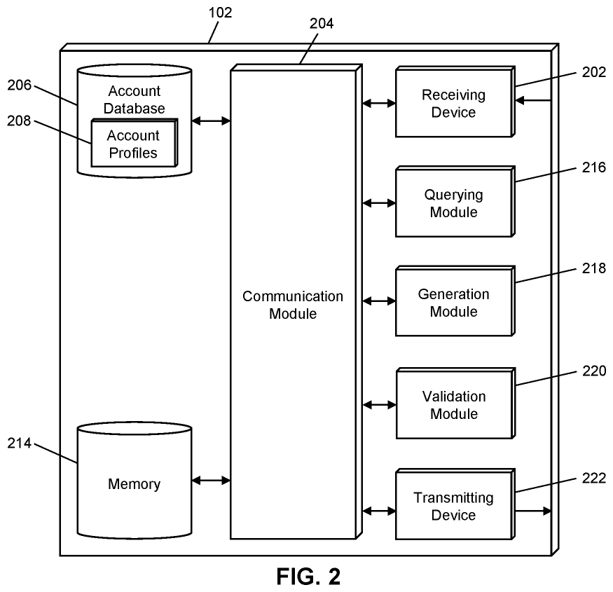

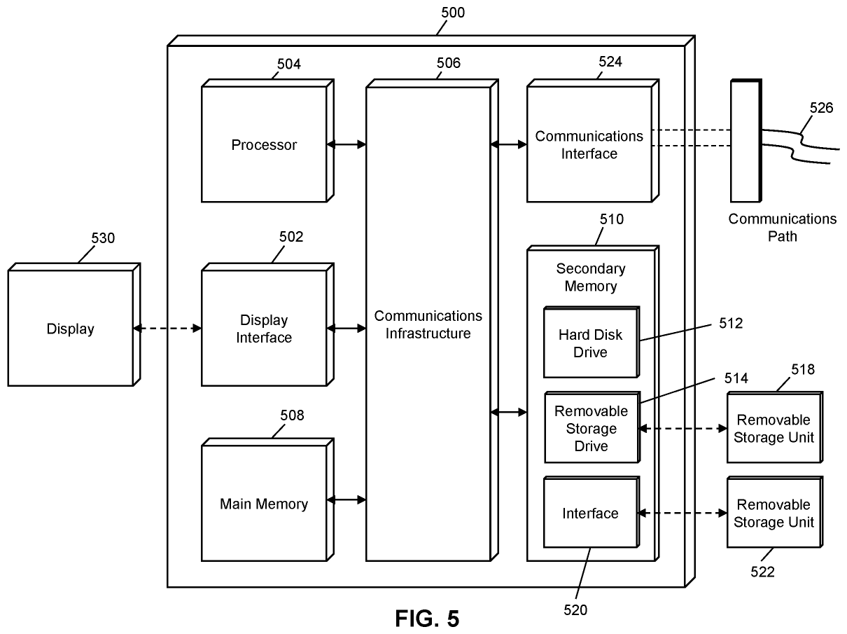

FIG. 1 illustrates a system 100 for the facilitating of permission-based cryptographic transactions for a blockchain that satisfies compliance with any applicable regulations without the exchange of personally identifiable information (PII). The system 100 can include a processing server 102, discussed in more detail below, that can operate a token identity service to facilitate the permission-based transactions. The system 100 can also include a blockchain network 104. The blockchain network 104 can be comprised of a plurality of blockchain nodes 106. Each blockchain node 106 can be a computing system, such as illustrated in FIG. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 can be a blockchain node 106 in the blockchain network 104.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UN IX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in a blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104 using the public key of the cryptographic key pair. In some cases, the term “blockchain wallet” can refer specifically to the private key. In other cases, the term “blockchain wallet” can refer to a computing device (e.g., user device 108a, service provider 110a, etc.) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender (e.g., user device 10b, service provider 110b, etc.) that is generated using the sender's private key, a blockchain address of the recipient of currency generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in a blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

The system 100 can include user devices 108, illustrated in FIG. 1 as a first user device 108a and a second user device 108b. Each user device 108 can be a device utilized by a participant in the blockchain associated with the blockchain network 104 to perform functions associated with the blockchain. In the system 100, a participant in the blockchain can interact with the blockchain through a service provider 110. Service providers 110 can interact directly with blockchain nodes 106 on behalf of participants to provide convenience, value-added services, security, etc. to participants. In some cases, service providers 110 can store keys for blockchain wallets that are associated with participants (e.g., similar to a bank maintaining an account used by a customer). In other cases, user devices 108 can retain the private key for their blockchain wallet, with communications going to the blockchain network 104 via the service provider 110. In the industry, service providers 110 can sometimes be referred to as “virtual asset service providers” or “VASPs.” In some cases, each participant in a transaction can utilize a different service provider 110. In other cases, both participants to a transaction can utilize the same service provider 110.

In the system 100, cryptographic transactions that are conducted using the blockchain can be subject to one or more policies, regulations, requirements, restrictions, etc., collectively referred to herein as regulations. Regulations can be set by the blockchain network 104, service providers 110, governmental agencies, financial institutions, standardization bodies, or other suitable entities. Regulations can apply to any aspect of a transaction or individuals involved in the transaction. In an example, a country can require that any individuals engaged in cryptographic transactions in that country must have their identity verified. In another example, transactions involving a certain class of goods (e.g., alcohol) can require both participants to the transaction being of a certain age. In some cases, regulations can apply to a single participant to a transaction (e.g., location-specific regulations applying only to participants in that location). In other cases, regulations can apply to both participants in a transaction, such as where one country can require both participants to a transaction, even if only one participant is located in that country, to satisfy their applicable regulations.

In order to ensure compliance with the applicable regulations, traditionally, each service provider 110 identifies all applicable regulations, performs all the verifications necessary of each participant, and verifies compliance. To accomplish such a task, service providers 110 can exchange PII for participants, so that the service provider 110b can verify the identity of the participant behind the user device 108a, for example. Each time the same participant transactions with another participant that uses a different service provider 110, that participant's PII is provided to the new service provider 110, resulting in the participant's PII being spread across a lot of systems and through a lot of transfers, drastically increasing the potential for compromise of their data.

To resolve such issues and to enable service providers 110 to focus solely on their own participants, the processing server 102 can provider a token identity service that uses permission tokens in order to quickly and accurately provide information regarding regulation compliance. In the system 100, when a new participant of the blockchain registers with a service provider 110, the service provider 110 verifies the participant's identity and collects any other suitable information that can be necessary for compliance with any potential regulations. The service provider 110 can verify the identity and other data using any suitable method. The verified data, referred to herein as verified identity data points or verified identity attributes, can be obtained and stored by the service provider 110 in any suitable manner, such as in compliance with any regulations applicable to the storage of PII or other identity data. Identity attributes can include any attributes for which regulations may be applied for a cryptographic transaction, such as level of identity verification (e.g., identified via name, identified via photo, multiple types of identity verification, etc.), age, geographic location, income, compliance with regulatory bodies, etc. For example, a service provider 110 can verify a participant's identity and age via a driver's license, and store attributes indicating the participant's age and that the identity was successfully verified by their state government. In another example, a service provider 110 can verify a participant's identity and age through their national government (e.g., via a passport) as well as verify their geographic location through their state government, and store attributes indicating that identity and age are verified at the national level and location verified at the state level.

Once the service provider 110 has verified the participant's identity attributes, the participant can be registered with the token identity service via the processing server 102. In some cases, communications with the processing server 102 can be performed by the service provider 110 on behalf of the participant. In other cases, the participant can communicate directly with the processing server 102 using their user device 108. In such cases, the participant can provider information identifying the service provider 110 through which their identity has been verified. Registration of the participant with the processing server 102 can include the transmission of permission data in the verified identity attributes as well as identification information regarding the blockchain wallet to which the identity attributes pertain. In some cases, the identification information can be the public key of the blockchain wallet. In other cases, the identification information can be a unique value suitable for use by the service provider 110 in identifying the participant and their stored data.

The processing server 102 can receive the verified identity attributes and identification information for the participant. In cases where the processing server 102 receives registration data from the user device 108, the processing server 102 can identify the service provider 110 using the provided information to verify or request the verified user identity attributes. In an exemplary embodiment, the processing server 102 can receive only the attributes without any PII for the participant. For instance, the attributes can include that the participant's identity was double verified on a national level, without including any information regarding that identity.

After receiving the attributes, the processing server 102 can generate a permission token for the participant. The permission token can be a digital token that includes the attributes in a standardized format that includes fields for all identity attributes that can be necessary to ensure compliance with applicable regulations. For example, the permission token can include a separate data field for identity verification for multiple levels and for each country, as well as data fields for income, age, state, city, country, education level, etc. In cases where the processing server 102 has not been provided attribute data for such a field, the field can remain empty or null. In some cases, a permission token can include fields indicating compliance with identity requirements in each country where participants to the blockchain are included. For example, if there are participants in twenty different countries, the permission token can include a field indicating compliance or non-compliance with the regulations for each of those twenty countries. The processing server 102 can be configured to determine compliance based on the regulations for each country and the supplied identity attributes. In some cases, the processing server 102 can be configured to determine compliance for any regulations, such as can be imposed or presented by any suitable entity, such as financial institutions, standardization bodies, etc. For instance, a service provider 110 can verify a participant's identity at a level suitable for United States regulations but not at a level suitable for European Union regulations. In such an instance, that participant's permission token can indicate U.S. compliance and E.U. non-compliance.

In addition to the permission token, the processing server 102 can generate an alias for the participant. The alias can be a value that is unique to the participant and directly associated with their participant's permission token that can be used for identification of the participant and their permission token across service providers 110. The processing server 102 can return the alias to the user device 108 (e.g., directly or via the service provider 110). The participant can then send their alias to another participant via their user device 108 and the other participant's user device 108 when a new transaction is desired. In some instances, a participant can request a specific alias during the registration process. In some embodiments, a participant can link their alias across multiple service providers 110. For example, a participant can have three different blockchain wallets managed by three different service providers 110 and can register with the processing server 102 (e.g., via their user device 108) to have the alias associated with all three blockchain wallets. In such embodiments, the participant can select which blockchain wallet to be used for sending or receiving currency for a specific transaction. In some cases, an alias can have subsections or components indicating the service provider. For instance, a participant, Jane, can request the alias “jane” where a service provider used for a transaction can be indicated in part of the full alias, such as jane.vaspone.tokenservice for a first service provider 110 and jane.vasptwo.tokenservice for a second service provider 110. In these embodiments, the participant can deactivate one or more blockchain wallets for use in future cryptographic transactions and/or delete blockchain wallets from their account entirely.

In cases where the processing server 102 can provide for multiple blockchain wallets linked to a single participant via their alias, such data can be stored in the following example format:
accountAlias: ACC55059970032193496
   status: ACTIVE
   crypto-addresses:
      cryptoAddressId: 52c3837d-cf45-4830-b1cf-60f2616bfa04
      status: ACTIVE
      asset: BTC
      blockchainAddress: mu692DY2GwYXbWdv3wUsQRr6nXsYW8QRsm
      cryptoAddressId: 52c3837d-cf45-4830-b1cf-60f2616bfa05
         status: ACTIVE
         asset: ETH
         blockchainAddress: ‘0x46Be1B5b35708e369b943CE6094c6f0484d480A7’
   createdDate: ‘2022-03-20T09:12:28-05:00’
   updatedDate: ‘2022-03-20T12:18:36-05:00’

In such an example, the participant with an alias of ACC55059970032193496 (e.g., which can be a hash of the alias issued to the participant or otherwise mapped to the issued alias) has two blockchain wallets registered with the processing server 102 for use with the alias, one that uses BTC and the other that uses ETC. As indicated in the profile, both are active and thus can be used to send or receive currency using the provided addresses.

In an example transaction, a first participant located in the U.S., Alice, using the first user device 108a, can have their identity verified by the first service provider 110a and can be registered with the token identity service and issued an alias of alias.usa.tokenservice. A second participant, Bob, located in Canada, uses a second service provider 110b for interacting with the blockchain and is interested in purchasing a product Alice has for sale for ten units of cryptocurrency via a cryptographic transaction on the blockchain. In order to receive payment, Alice can provide her alias to Bob by transmitting the alias from her first user device 108a to Bob's second user device 108b. Bob can then, via the second user device 108b, submit a request to the second service provider 110b to send ten units of cryptocurrency to the alice.tokenservice alias. The second service provider 110b can send a request to the processing server 102 via a suitable communication network and method for Alice's permission token by including the alice.usa.tokenservice alias.

The processing server 102 can receive the alias and identify the permission token associated therewith. The processing server 102 can then electronically transmit the permission token back to the service provider 110b. The service provider 110b can then view the verified identity attributes in the permission token to determine if Alice has had her identity verified in a manner that is suitable for any regulations applicable to the cryptographic transaction for payment of the ten units of cryptocurrency from Bob. If the service provider 110b is satisfied that everything is compliant, the service provider 110b can submit a request for the new cryptographic transaction to a blockchain node 106 for addition to the blockchain using traditional methods. The request can include the digital signature from Bob's blockchain wallet (e.g., performed by the second service provider 110b or supplied by Bob's second user device 108b when requesting the transaction) as well as the destination address for Alice's blockchain wallet. In some cases, the destination address can be provided by the processing server 102 with the permission token, generated using the public key provided by the processing server 102 with the permission token, provided by the first user device 108a when providing the alias, or requested from the first service provider 110a after verification of compliance by the second service provider 110b.

The result is a successful cryptographic transaction on the blockchain between two participants where compliance with all applicable regulations is ensured. In a traditional system, the service providers 110a and 110b would have had to exchange Alice's and Bob's PII to verify each identity in a manner that was suitable for all applicable regulations including those of both the United States and Canada, which would require each service provider 110a and 110b to be familiar with all regulations of both countries as well as rules regarding the receipt and storage of PII for both countries. In the system 100, the first service provider 110a is only responsible for verifying the identity of their participant, Alice, and be aware of the identity requirements for transactions in Alice's country, the United States. The second service provider 110b is only responsible for verifying Bob's identity and the identity requirements for transactions in Canada, Bob's country. By utilizing the permission token from the token identity service, the second service provider 110b can verify that Alice's identity has been verified and is compliant with U.S. regulations and can also identify if the identity verification is suitable for transacting with a Canadian based on the attributes included therein. The transaction is successfully conducted without the exchange of any PII and, in some cases, without a service provider 110 having to be individually aware of the regulations of all possible jurisdictions if such data is indicated in the permission token. The result is a significant improvement in processing speed, user security, and resource expenditure for cryptographic transactions. Additionally, in some embodiments, service providers 110 do not have to communicate directly with other service providers 110, allowing a significantly greater reach and participation for all participants and service providers 110 over traditional systems.

In another example transaction, the service providers 110 can perform the identity verification themselves. In such an instance, the permission token can include an attestation by the service provider 110 instead of verified identity attributes. In the example, Alice can provide her alias to Bob using their user devices 108a and 108b. As part of the process, the first service provider 110a can attest that Alice is permitted to participate in a transaction with Bob. Such an attestation can be a digital signature generated by the first service provider 110a or other format suitable for verification by the second service provider 110b as genuine from the first service provider 110a and indicative of Alice's permission to participate in the transaction. Bob can submit the transaction request with Alice's alias to the second service provider 110b, which can request the permission token from the processing server 102 that is associated with the alias. The processing server 102 can identify the permission token, which can include the attestation from the first service provider 110a and provide the permission token to the second service provider 110b. The second service provider 110b can verify the attestation and Alice's permission to participate in the cryptographic transaction and then proceed with the cryptographic transaction. In some cases, the second service provider 110b can provide an attestation for Bob's permission to participate in the transaction, which can be provided to the processing server 102 when requesting the permission token, which can be provided to the first service provider 110a and/or verified by the first service provider 110a and/or processing server 102 before providing the permission token to the second service provider 110b.

In some embodiments, one or more of the functions discussed herein can be performed by a smart contract that is stored on the blockchain. A smart contract can be stored on the blockchain and configured to self-execute when one or more conditions are met. In the system 100, a smart contract can be configured to receive permission tokens and transaction data as input, which can result in self-execution where the smart contract verifies if compliance with applicable regulations is met based on the input permission token. If verification is successful, the smart contract can generate the new blockchain transaction and submit it to a blockchain node 106 for addition to the blockchain. In another example, a smart contract can be used to provide permission tokens or destination addresses when supplied with an alias.

In one example, a smart contract can be used to affect the transfer with the identity verification being performed by the service providers 110. In such an example, the first service provider 110a and second service provider 110b can each verify compliance of their respective users with applicable identity regulations using methods discussed above. In some cases, the first service provider 110a and second service provider 110b can exchange notifications indicating the successful verification. The first service provider 110a can, on behalf of the first user, indicate to a smart contract stored on the blockchain that the cryptographic currency is authorized for transfer to the second user. The smart contract can then execute to add a new cryptographic transaction to the blockchain for transfer of the currency to the second user's blockchain wallet (e.g., second user device 108b). In a second example, the first service provider 110a can indicate to the smart contract stored on the blockchain that the cryptographic currency is authorized for transfer, and the smart contract can verify compliance with the identity requirements for both users prior to executing the transfer. The smart contract can perform the verification using the methods discussed above, such as by receiving a permission token for each participant from the processing server 102, receive the attestations and confirm them with the processing server 102. In a third example, the first service provider 110a can indicate authorization for transfer to a first smart contract, which can then call a second smart contract for performing the compliance check for identity verification requirements. In such an example, the first smart contract or the second smart contract can be configured to add the new cryptographic transaction to the blockchain upon successful verification. In some embodiments, the processing server 102 can be configured to generate the smart contracts discussed above and provide smart contracts to blockchain nodes 106 for addition to the blockchain, such as during registration of a participant or when a new transaction is requested.

In some instances, service providers 110 can be required to directly exchange data regarding participants for compliance with requirements. For example, some transactions can require the reporting of one or more identity attributes instead of simply verifying compliance of identity attributes with requirements, such as transactions where a travel rule is applicable. In such instances, the service providers 110 can communicate directly using a suitable communication network and method or can communicate via the processing server 102, where the processing server 102 can direct communications to the appropriate service provider 110, which can enable any service provider 110 to engage in a transaction with any other service provider 110 without the need for obtaining detailed communication information for all other service providers 110. In cases where identity attributes are exchanged, the service providers 110 can ensure compliance with any regulations regarding the transmission and receipt of such data.

In instances where the processing server 102 participates in the exchange, the transfer can utilize encryption, hashing, and other techniques to ensure that the processing server 102 does not obtain any readable personally identifiable information. In an example, a first service provider 110a can encrypt the first participant's identity attributes using a public key of a cryptographic key pair of the second service provider 110b, while the second service provider 110b can encrypt the second participant's identity attributes using a public key of a cryptographic key pair of the first service provider 110a. The encrypted data can be provided by each service provider 110 to the processing server 102, which can provide the encrypted data to the other service provider 110. Each service provider 110 can then decrypt the identity attributes using their own private key, resulting in an exchange of PI 1 between service providers 110 without any PI 1 being exposed to the processing server 102. In some cases, the processing server 102 can exchange the public keys, which can enable the data exchange to occur without any direct communication between service providers 110.

### Processing Server

FIG. 2 illustrates an embodiment of the processing server 102 in the system 100 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102. In some cases, other components of the system 100, such as the blockchain nodes 106, user devices 108, and service providers 110 can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from blockchain nodes 106, user devices 108, service providers 110, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes 106 that are superimposed or otherwise encoded with blockchain data entries, requests for blockchain data, confirmation messages, cryptographic keys, smart contracts, etc. The receiving device 202 can also be configured to receive data signals electronically transmitted by user devices 108 that can be superimposed or otherwise encoded with alias requests, verified identity attributes, identification values, service provider information, public keys, destination addresses, etc. The receiving device 202 can also be configured to receive data signals electronically transmitted by service providers 110 that are superimposed or otherwise encoded with alias requests, permission token requests, identification values, verified identity attributes, updates to verified identity attributes, public keys, destination addresses, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include an account database 206. The account database 206 can be configured to store one or more account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to a permission account. For example, an account profile 208 can include a permission token, identification information, service provider information, alias, verified user identity attributes, registered blockchain wallets, blockchain addresses, currency balances, wallet status, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, regulations, location data, permission data, cryptographic keys, algorithms, etc.

The processing server 102 can include a querying module 216. The querying module 216 can be configured to execute queries on databases to identify information. The querying module 216 can receive one or more data values or query strings and can execute a query string based thereon on an indicated database, such as the memory 214 of the processing server 102 to identify information stored therein. The querying module 216 can then output the identified information to an appropriate engine or module of the processing server 102 as necessary. The querying module 216 can, for example, execute a query on the account database 206 to identify an account profile 208 for which a permission token is requested via an alias.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate smart contracts, blockchain data entries, blocks, confirmation messages, permission tokens, aliases, destination addresses, etc.

The processing server 102 can also include a validation module 220. The validation module 220 can be configured to perform data validations and verifications for the processing server 102 as part of the functions discussed herein. The validation module 220 can receive instructions as input, can perform data validations or verification as instructed, and can output a result of the data validations or verifications to one or more modules of the processing server 102. In some cases, the input can include the data to be validated or verified and/or data to be used in the validation or verification. In other cases, the validation module 220 can be configured to identify such data, such as in the account database 206 and/or memory 214. The validation module 220 can be configured to, for example, verify regulation compliance, validate new blockchain data entries and/or blocks, verify digital signatures, etc.

The processing server 102 can also include a transmitting device 222. The transmitting device 222 can be configured to transmit data over one or more networks via one or more network protocols. In some instances, the transmitting device 222 can be configured to transmit data to blockchain nodes 106, user devices 108, service providers 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to blockchain nodes 106 that are superimposed or otherwise encoded with blockchain data entries, blockchain data requests, blocks, confirmation messages, response messages, etc. The transmitting device 222 can also be configured to electronically transmit data signals to user devices 108 that are superimposed or otherwise encoded with aliases, confirmation messages, destination addresses, data requests, etc. The transmitting device 222 can be further configured to electronically transmit data signals to service providers 110, which can be superimposed or otherwise encoded with aliases, permission tokens, identification information, destination addresses, data requests, verified identity attribute requests, etc.

### Process for Permission-Based Cryptographic Transactions

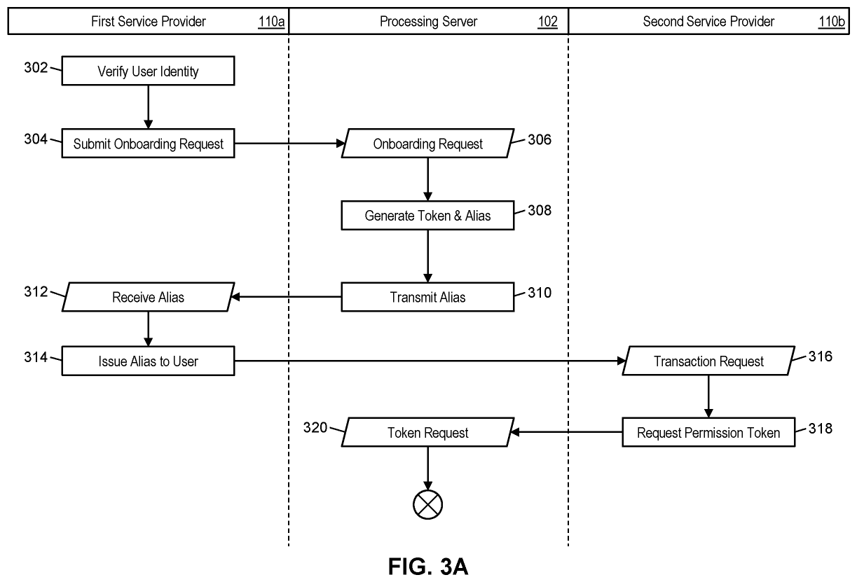

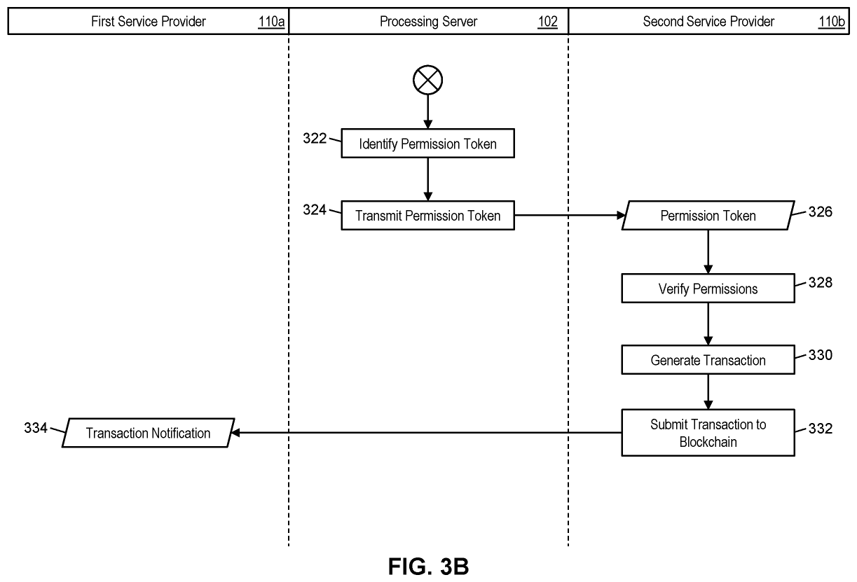

FIGS. 3A and 3B illustrate a process in the system 100 of FIG. 1 for the facilitation of permission-based cryptographic transactions on a blockchain associated with the blockchain network 104. In step 302, the first service provider 110a can verify the identity of a participant in the blockchain that is registered with the first service provider 110a using suitable methods. As part of the verification of the identity of the participant, the first service provider 110a can collect verified user identity attributes, which can include levels of verification and other verified user data, such as age, income, geographic location, etc. In step 304, the first service provider 110a can electronically transmit an onboarding request to the processing server 102 via a suitable communication network and method. The onboarding request can include at least identification information for the participant and the verified user identity attributes.

In step 306, the receiving device 202 of the processing server 102 can receive the onboarding request from the first service provider 110a. In step 308, the generation module 218 of the processing server 102 can generate a permission token and alias for the participant. The permission token can include a plurality of data fields for identity attributes used in regulation compliance where the data values for the data fields are based on the verified user identity attributes received in the onboarding request. In some cases, the alias can include a reference to the first service provider 110a and/or any of the verified user identity attributes. In step 310, the transmitting device 222 of the processing server 102 can electronically transmit the alias to the first service provider 110a in response to the onboarding request.

In step 312, the first service provider 110a can receive the alias for the participant. In step 314, the first service provider 110a can issue the received alias to the participant, such as via the first user device 108a. The participant can then transmit the alias to another participant that is registered with a second service provider 110b via the first user device 108a. The other participant can then submit a transaction request to the second service provider 110b using their user device 108b, where the transaction request includes at least the alias, a transaction amount, and any other data suitable for use in a cryptographic transaction, such as unspent transaction outputs, digital signature, etc. In step 316, the second service provider 110b can receive the transaction requested.

In step 318, the second service provider 110b can electronically transmit a request for a permission token to the processing server 102 using a suitable communication network and method. The request can include at least the alias received in the transaction request. In step 320, the receiving device 202 of the processing server 102 can receive the permission token request. In step 322, the querying module 216 of the processing server 102 can identify the permission token for the first participant in an account profile 208 associated therewith identified via the received alias. In step 324, the transmitting device 222 of the processing server 102 can electronically transmit the identified permission token for the first participant to the second service provider 110b in response to the permission token request.

In step 326, the second service provider 110b can receive the permission token. In step 328, the second service provider 110b can verify that the identity of the first participant is in compliance with any applicable and regulations based on the data values in the data fields in the permission token. As part of the verification, the second service provider 110b can verify, or have already verified via the registration process, compliance of the second participant in terms of identity verification. Once the second service provider 110b has verified that the transaction is compliant with all applicable regulations, then, in step 330, the second service provider 110b can generate a new blockchain transaction. The new blockchain transaction can include at least the transaction amount, destination address, unspent transaction outputs, digital signature, and any other data necessary for the blockchain transaction.

In step 332, the second service provider 110b can submit the new blockchain transaction to a blockchain node 106 in the blockchain network 104 using suitable communication methods, as well as notifying the first service provider 110a when the transaction has been added to the blockchain. The blockchain node 106 can then confirm the transaction, which can be included in a new block that is generated, confirmed, and added to the blockchain. In step 334, the first service provider 110a can notify the first participant that the transaction involving the first participant was successfully added to the blockchain. The result of the process is that the first and second participants, each of which use different service providers 110, participate in a cryptographic transaction on the blockchain that is compliant with all applicable regulations without the need for the exchange of PII and separate verifications of both participants by each service provider 110.

### Exemplary Method for Permission-Based Cryptographic Transactions

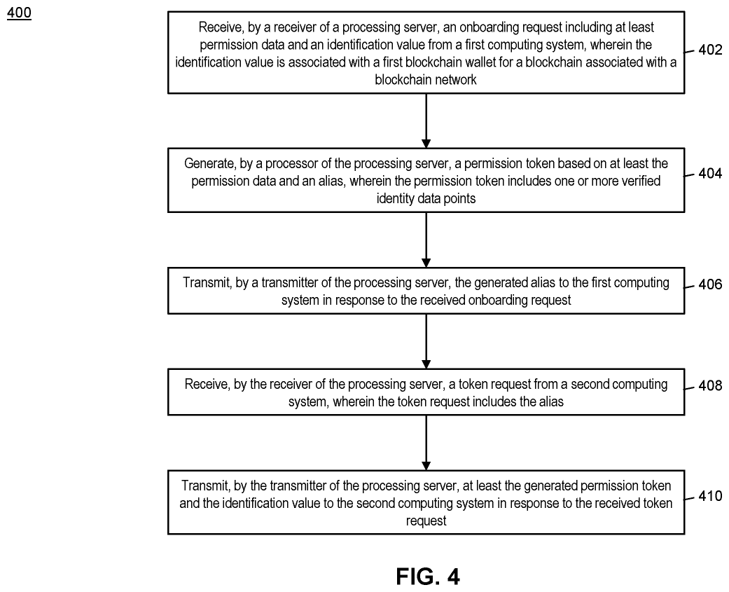

FIG. 4 illustrates a method 400 for the facilitation of a permission-based cryptographic transaction on a blockchain via the use of a permission token.

In step 402, an onboarding request including at least permission data and an identification value is received by a receiver (e.g., receiving device 202) of a processing server (e.g., processing server 102) from a first computing system (e.g., first service provider 110a), wherein the identification value is associated with a first blockchain wallet for a blockchain associated with a blockchain network (e.g., blockchain network 104). In step 404, a permission token based on at least the permission data and an alias are generated by a processor (e.g., generation module 218) of the processing server, wherein the permission token includes one or more verified identity data points.

In step 406, the generated alias is transmitted by a transmitter (e.g., transmitting device 222) of the processing server to the first computing system in response to the received onboarding request. In step 408, a token request is received from a second computing system (e.g., second service provider 110b), wherein the token request includes the alias. In step 410, at least the generated permission token and the identification value can be transmitted by the transmitter of the processing server to the second computing system in response to the received token request.

In one embodiment, the identification value can be a public key associated with the first blockchain wallet. In some embodiments, the one or more verified identity data points can include at least one of: geographic location, age, income, identity verification status, compliance status, etc. In one embodiment, the generated permission token does not include any personally identifiable information. In some embodiments, the onboarding request does not include any personally identifiable information. In one embodiment, the method 400 can also include: generating, by the second computing system, a new blockchain transaction that includes at least a transaction amount, one or more unspent transaction outputs and one of the identification value or a destination address generated using the identification value; and transmitting, by the second computing system, the generated new blockchain transaction to a blockchain node (e.g., blockchain node 106) in the blockchain network for addition to the blockchain. In a further embodiment, the method 400 can even further include verifying, by the second computing system, compliance of the first blockchain wallet with one or more applicable regulations based on the one or more verified identity data points included in the received permission token prior to generating the new blockchain transaction.

### Computer System Architecture

FIG. 5 illustrates a computer system 500 in which embodiments of the present disclosure, or portions thereof, can be implemented as computer-readable code. For example, the processing server 102, blockchain nodes 106, user devices 108, and service providers 110 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for facilitating permission-based cryptographic transactions across service providers. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for facilitating permission-based cryptographic transactions across service providers, comprising:
receiving, by a receiver of a processing server, an onboarding request including at least permission data and an identification value from a first computing system, wherein the identification value is associated with a first blockchain wallet for a blockchain associated with a blockchain network;
generating, by a processor of the processing server, a permission token based on at least the permission data and an alias, wherein the permission token includes one or more verified identity data points;
transmitting, by a transmitter of the processing server, the generated alias to the first computing system in response to the received onboarding request;
receiving, by the receiver of the processing server, a token request from a second computing system, wherein the token request includes the alias; and
transmitting, by the transmitter of the processing server, at least the generated permission token and the identification value to the second computing system in response to the received token request.

2. The method of claim 1, wherein the identification value is a public key associated with the first blockchain wallet.

3. The method of claim 1, wherein the one or more verified identity data points includes at least one of: geographic location, age, income, identity verification status, compliance status, etc.

4. The method of claim 1, wherein the generated permission token does not include any personally identifiable information.

5. The method of claim 1, wherein the onboarding request does not include any personally identifiable information.

6. The method of claim 1, further comprising:
generating, by the second computing system, a new blockchain transaction that includes at least a transaction amount, one or more unspent transaction outputs and one of the identification value or a destination address generated using the identification value; and
transmitting, by the second computing system, the generated new blockchain transaction to a blockchain node in the blockchain network for addition to the blockchain.

7. The method of claim 6, further comprising:
verifying, by the second computing system, compliance of the first blockchain wallet with one or more applicable regulations based on the one or more verified identity data points included in the received permission token prior to generating the new blockchain transaction.

8. The method of claim 1, wherein
the first computing system is associated with a first virtual asset service provider, and
the second computing system is associated with a second virtual asset service provider.

9. A system for facilitating permission-based cryptographic transactions across service providers, comprising:
a blockchain network;
a first computing system;
a second computing system; and
a processing server, the processing server including a receiver receiving an onboarding request including at least permission data and an identification value from the first computing system, wherein the identification value is associated with a first blockchain wallet for a blockchain associated with the blockchain network,
a processor generating a permission token based on at least the permission data and an alias, wherein the permission token includes one or more verified identity data points, and
a transmitter transmitting the generated alias to the first computing system in response to the received onboarding request, wherein
the receiver of the processing server receives a token request from the second computing system, wherein the token request includes the alias, and
the transmitter of the processing server transmits at least the generated permission token and the identification value to the second computing system in response to the received token request.

10. The system of claim 9, wherein the identification value is a public key associated with the first blockchain wallet.

11. The system of claim 9, wherein the one or more verified identity data points includes at least one of: geographic location, age, income, identity verification status, compliance status, etc.

12. The system of claim 9, wherein the generated permission token does not include any personally identifiable information.

13. The system of claim 9, wherein the onboarding request does not include any personally identifiable information.

14. The system of claim 9, wherein the second computing system
generates a new blockchain transaction that includes at least a transaction amount, one or more unspent transaction outputs and one of the identification value or a destination address generated using the identification value, and
transmits the generated new blockchain transaction to a blockchain node in the blockchain network for addition to the blockchain.

15. The system of claim 14, wherein the second computing system verifies compliance of the first blockchain wallet with one or more applicable regulations based on the one or more verified identity data points included in the received permission token prior to generating the new blockchain transaction.

16. The system of claim 9, wherein
the first computing system is associated with a first virtual asset service provider, and
the second computing system is associated with a second virtual asset service provider.
